(19) United States
(12) Patent Application Publication
(10) Pub. No.: US 2003/0084423 A1
(43) Pub. Date: May 1, 2003

(54) Automatic source code generation

(76) Inventors: Dai Clegg, Berkshire (GB); Alan Gibson, Berkshire (GB); John Blair, Berkshire (GB)

Correspondence Address: SWIDLER BERLIN SHEREFF FRIEDMAN, LLP, 3000 K STREET, NW, BOX IP, WASHINGTON, DC, 20007, US

(21) Appl. No.: 09/983,913

(22) Filed: Oct. 26, 2001

(51) Int. Cl. G06F 9/44; G06F 17/60

(52) U.S. Cl. 717/105; 705/1

(57) ABSTRACT

A method for generating a hub and spoke messaging infrastructure for propagating messages used in the implementation of a process on a distributed system of computers, each of which is adapted to execute messaging software to enable each computer to communicate with the others in a distributed system. The method comprises the steps of producing a graphical description of the process -and automatically creating source code for generating the hub and spoke messaging infrastructure by selecting and adapting appropriate portions of predefined source code in accordance with the graphical description of the process, the predefined source code using the messaging software to control the routing of messages between the computers.

This invention relates to a method and apparatus for automatically creating the source code to generate a hub and spoke messaging infrastructure.

In the context of this specification, the term source code includes metadata for directing the operation of a software application.

The hub and spoke messaging system for communication between computers is well known. In this system, one computer sends a message to another computer by sending the message to the hub where it is routed appropriately to the other computer. As such, all the software for handling messages between the computers resides on the hub and this provides an easily manageable and highly scalable messaging infrastructure. The system has particular utility in the implementation of business processes.

Conventionally, a business process diagram is drawn by a business person and then presented to a software developer who creates source code to generate the hub and spoke messaging infrastructure for implementing the business process on a distributed system of computers. However, this has the disadvantages that the source code may take a long time to create and that creation of the source code is not easily traceable from the business process description.

In accordance with a first aspect of the present invention, there is provided a method for generating a hub and spoke messaging infrastructure for propagating messages used in the implementation of a process on a distributed system of computers, each of which is adapted to execute messaging software to enable each computer to communicate with the others in the distributed system, the method comprising producing a graphical description of the process and automatically creating source code for generating the hub and spoke messaging infrastructure by selecting and adapting appropriate portions of predefined source code in accordance with the graphical description of the process, the predefined source code using the messaging software to control the routing of the messages between the computers.

In accordance with a second aspect of the present invention, there is provided an apparatus comprising a processor adapted to execute a program for capturing a graphical description of a process and automatically creating source code for generating a hub and spoke messaging infrastructure by selecting and adapting appropriate portions of predefined source code in accordance with the graphical description of the process.

Hence, the invention provides a method for quickly creating traceable source code for generation of an easily scalable hub and spoke messaging infrastructure for implementing a business process on a distributed system of computers.

Advantageously, the graphical description is a unified modeling language (UML) Activity Graph description. UML is an open standard, general purpose notational language for specifying large object oriented software projects.

Normally, the graphical description comprises one or more of activities, objects, decision points, message routes and partitions, each partition corresponding to one of the computers making up the distributed system, and the production of the graphical description typically further comprises the following steps:

a associating at least one channel having channel properties with each partition;

b assigning one channel to each message route;

c associating a respective section of user defined source code with each decision point, the user defined source code determining which one of a plurality of message routes the message is to be propagated by; and,

d designating one of the computers as the hub.

The sections of user defined source code associated with the decision points may determine which message route the message is to be propagated by according to a variety of conditions. In particular, they may determine the appropriate message route based on the content of the message.

The computer designated as the hub may also carry out a part of the process implementation. However, this is not essential and it is possible that the computer designated as the hub does not carry out any part of the process implementation.

In a preferred embodiment, the source code is automatically generated from the graphical description by:

a using the channel properties to define queue parameters for each channel so that appropriate queues for implementing each channel may be generated on the hub and spokes by the respective messaging software;

b generating a set of message propagation rules to be used by the messaging software running on the hub such that messages emanating from the queues on the spokes are transferred to the corresponding queues on the hub and messages emanating from the queues on the hub are transferred to the corresponding queues on the spokes;

c creating a deployment package of source code for each spoke, each deployment package comprising predefined source code for implementing the queue or queues on each respective spoke, the predefined source code being adapted in accordance with the queue parameters; and,

d creating a deployment package of source code for the hub, the deployment package comprising

i. predefined source code for implementing the queues on the hub, the predefined source code being adapted in accordance with the queue parameters;

ii. predefined source code for routing the messages, the predefined source code being adapted in accordance with the message propagation rules and including the sections of user defined source code associated with each decision point.

In the case where different computers of the distributed system require different message formats, the deployment package of source code for the hub may comprise predefined source code for transforming the format of the messages.

The invention will typically be provided as a computer program comprising computer program code means adapted to perform a method according to the first aspect of the invention when said program is run on a computer.

Further, there may be provided a computer program product comprising program code means stored on a computer readable medium for performing a method according to the first aspect of the invention when said program product is run on a computer.

An example of the invention will now be described with reference to the accompanying drawings, in which:

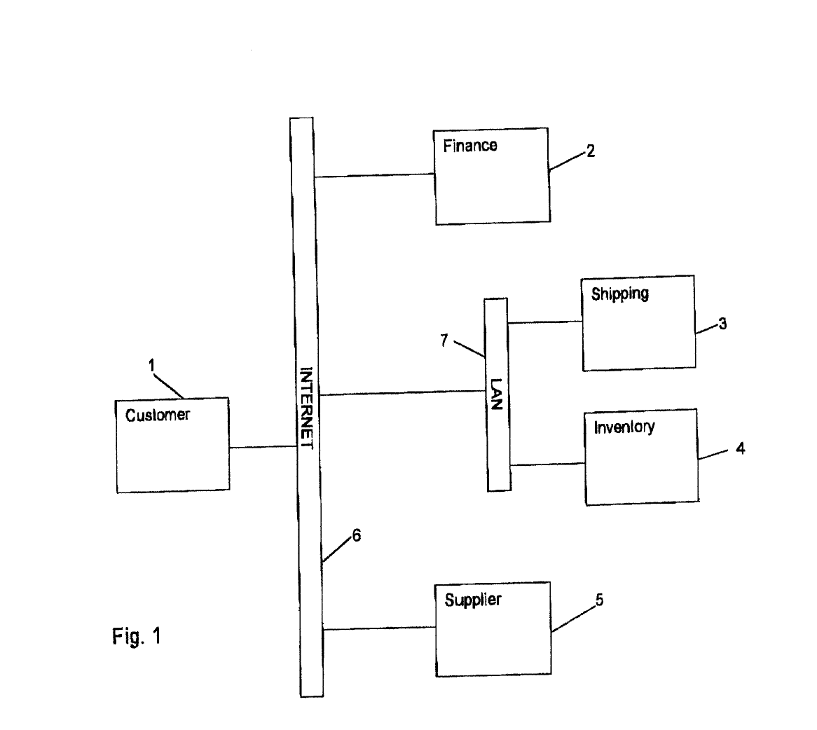

FIG. 1 shows a distributed system of computers;

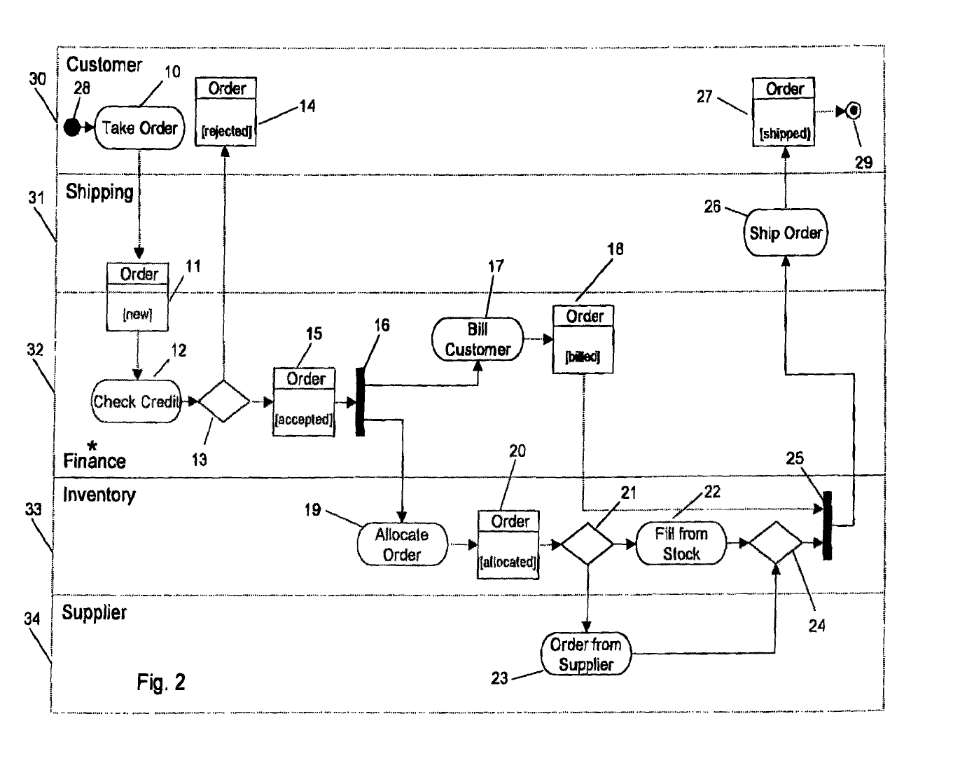

FIG. 2 shows, by way of example, a business process for which the messaging structure may be generated using the invention;

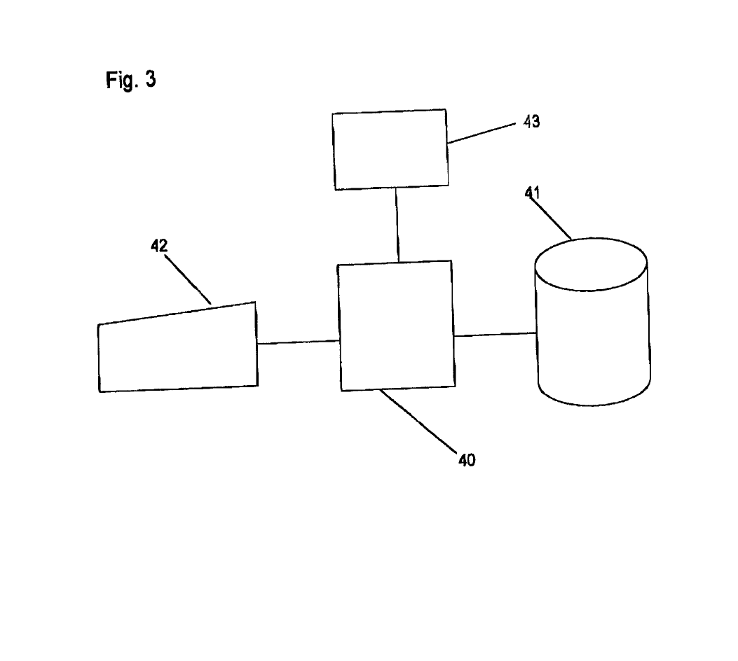

FIG. 3 shows apparatus for performing the invention;

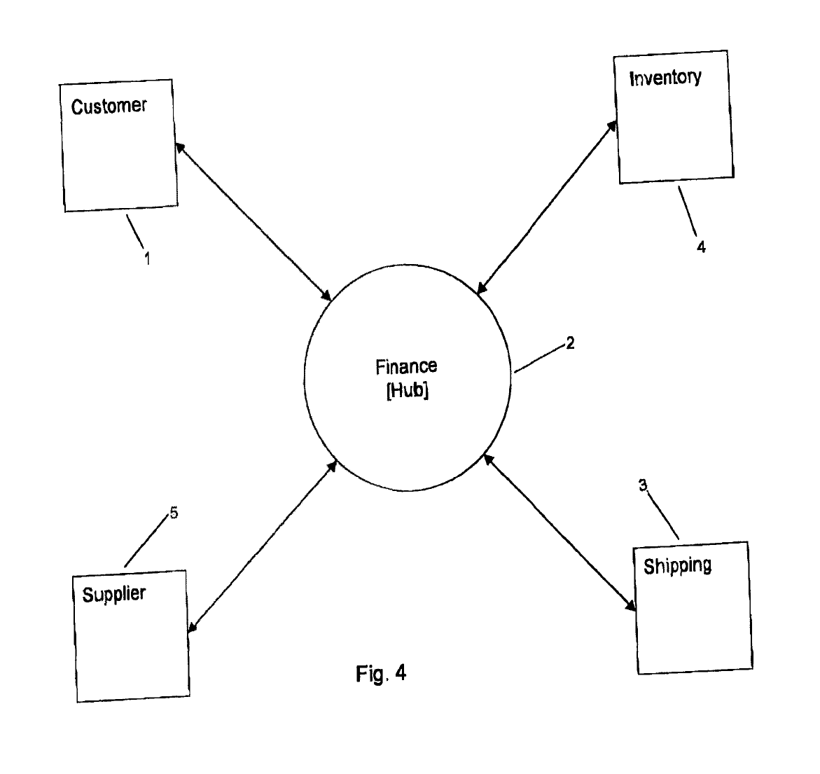

FIG. 4 shows an example of a hub and spoke infrastructure; and,

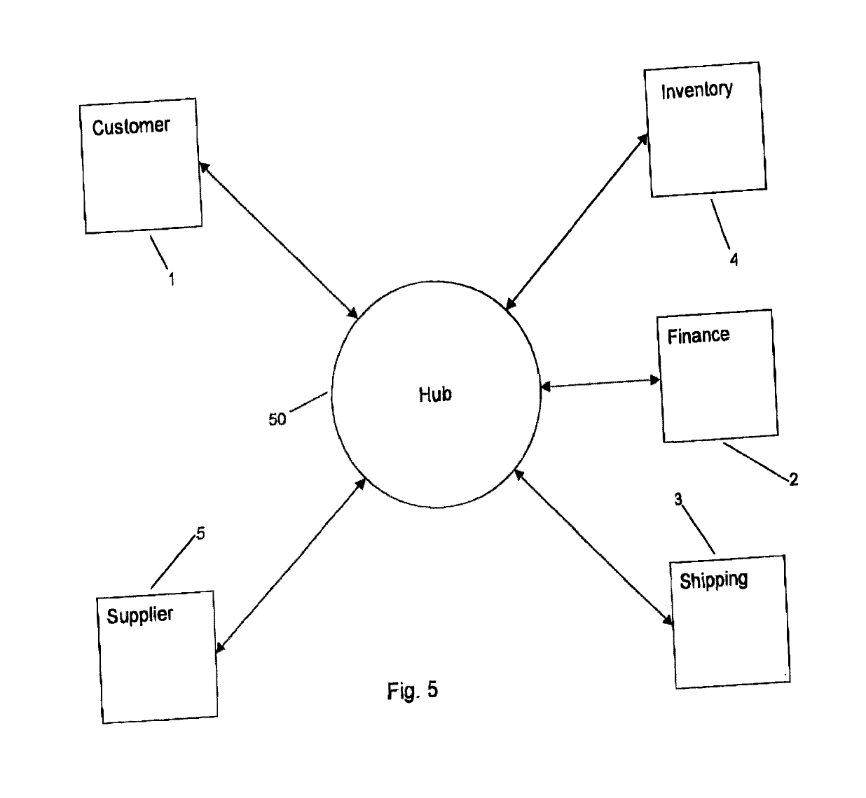

FIG. 5 shows another example of a hub and spoke infrastructure.

A distributed system of computers, such as may be used by a business offering a product for sale via the Internet, is shown in FIG. 1. A computer 1 designated “Customer” is connected to the Internet 6, to which are also connected a computer 2 designated “Finance”, a computer 5 designated “Supplier” and a local area network (LAN) 7. A computer 3 designated “Shipping” and a computer 4 designated “Inventory” are both connected to the LAN 7. The computers 2 to 4 designated “Finance”, “Shipping” and “Inventory” represent the company's computers whilst computer 1 designated “Customer” represents a computer owned by the company's customer and the computer 5 designated “Supplier” represents a computer owned by the company's supplier.

FIG. 2 shows a business process diagram drawn up to represent how orders may be taken from a customer and how these orders are processed.

The business process diagram is split into five partitions 30 to 34, known as swim lanes. Each swim lane 30 to 34 represents one computer of the distributed system. For example, swim lane 32 represents computer 2 designated finance. The correspondence between swim lanes 30 to 34 and the computers 1 to 5 can be determined by the label borne by each of the swim lanes 30 to 34.

The process starts with initial state 28 which precedes activity 10 designated “Take Order”. Activity 10 is situated in swim lane 30 indicating that it is performed by computer 1 designated “Customer”. Activity 10 generates an object 11 designated “Order”. The label in square brackets indicates the state of processing of the object 11. For example, the object 11 may contain a customer's name, address and credit card number along with the stock code and quantity of the product they have ordered. This order is presented to activity 12 which performs a credit check, for example by confirming that the credit limit on the customer's credit card is sufficient to pay for the product ordered. Decision point 13 takes the results from activity 12 and, if the credit check has failed, rejects the order producing object 14 or, if the credit check is successful, accepts the order producing object 15. Splitter 16 passes object is onto both activity 17 designated “Bill Customer” and activity 19 designated “Allocate Order”. Activity 17 prints an invoice for sending to the customer and generates object 18.

Activity 19 allocates stock to the order and generates object 20 which is sent either to activity 22 designated “Fill from Stock” or to activity 23 designated “Order from Supplier” depending on the outcome of a decision made by decision point 21. For example, decision point 21 may send all objects with a stock code higher than a certain value to activity 23 whilst those with a lower value proceed directly to activity 22. The object then proceeds from either activity 22 or activity 23 via decision point 24 to combiner 25 which sends both objects 18 and 20 to activity 26 designated “Ship Order” located in swim lane 31. Activity 26 dispatches the products ordered to the customer and generates object 27 to notify the customer that this has been done. The process ends with final state 29.

The business process diagram shown in FIG. 2 is created using apparatus shown schematically in FIG. 3. This shows a computer 40 connected to a database 41. The computer 40 executes software for producing a graphical description of a business process such as that shown in FIG. 2 in accordance with user input and stores it as a UML description. The user input is entered via input device 42 which may be any suitable device such as a keyboard or a mouse and the graphical description is displayed on display device 43. The database 41 contains a repository of source code which can be selected and adapted in accordance with the graphical description of the business process in order to generate the hub and spoke messaging infrastructure. It is important to realise that the repository of source code does not have to be stored in a database. It may alternatively be stored on a conventional file system or some other file store.

It is desired to produce from the business process diagram shown in FIG. 2 a hub and spoke messaging infrastructure such as that shown in FIG. 4. In this, the computer 2 designated “Finance” acts as the hub whilst the remaining computers 1 and 3 to 5 are the spokes around the hub. The business process diagram shown in FIG. 2 indicates that computer 2 designated “Finance” is to be the hub by the “*” shown in swim lane 32.

An alternative hub and spoke structure is shown in FIG. 5 where none of the computers 1 to 5 involved in the process implementation acts as the hub. Instead an independent computer 50 is used as the hub and this computer 50 has no involvement with the business process implementation.

A business process implemented in this way is easily modified as may be required since the software executing on computer 40 has the ability to modify the business process description in accordance with your input. This may be required if one of the computers 1 to 5 is changed for a different type of computer addition of another computer.

In FIG. 2, each of the activities is situated in a respective swim lane 30 to 34. This effectively allocates resources of the distributed system of computers to the activities and indicates from where and to where objects must be sent in order to carry out the business process. For example, the object 11 is generated by activity 10 and is to be sent to activity 12. In order to do this the object 11 is sent to the hub as a message. The hub then decides on the ultimate destination of the message and routes it accordingly. In this case, the message is destined for computer 2 designated finance which is the same computer as the hub.

In other cases the destination of the message is determined by its content and this is known as content based routing. For example, the object 20 is sent either to activity 22 or activity 23 depending on the value of its stock code. To do this, the activity 19 sends a message containing object 20 into the hub which examines the message and determines its correct destination which is either computer 4 designated “Inventory” or computer 5 designated “Supplier”.

In order to achieve this a section of user defined source code is associated with decision point 21 and it is this source code which instructs the hub to examine the message and determine its correct destination depending on the value of the stock code. Similarly, appropriate sections of the user defined source code will be associated with decision points 13 and 24.

The next step in the production of the graphical description is to associate at least one channel with each swim lane to provide for the transfer of messages between the partitions. For example, two channels may be assigned to swim lane 30, one for incoming and one for outgoing messages.

One channel is now assigned by the user via input device 42 to each message route which are the arrows linking the objects and activities in FIG. 2. The properties of the channels are then defined.

The properties of a channel may vary according to the protocol used to implement the channel. Examples of such protocols are File Transfer Protocol (FTP) and Hyper-Text Transfer Protocol (HTTP). The properties of a channel also specify how messages transmitted through the channel must be transferred so that the messages are in a format understood by the recipient.

For example, messages sent to and from computer 1 designated “Customer” may be in the form of e-mail messages whilst computer 4 designated “Inventory” requires messages in the form of an Extensible Mark-up Language (XML) file.

When an e-mail message emanates from computer 1 destined for computer 4 it must be converted to an XML file and the contents of the message may have to be transformed to match the specific requirements of computer 4. The operations required to do this may be performed at the message source, computer 1, in the hub or at the destination, computer 4. The properties of the channel at source and destination specify the operations required, where the operations are to be performed and may reference source code to perform these operations.

Furthermore, it may be that some computers have a different physical interface. For example, the computer 3 designated “Shipping” may expect a manual entry via a keyboard and in this case it is necessary to include an extra piece of hardware between LAN 7 and computer 3 to adapt the message format transmitted by the hub over LAN 7 such that it mimics the required keyboard input.

It is now possible for the software executing on computer 40 to generate automatically the source code from the graphical description. A deployment package of source code is created for each spoke and for the hub. Firstly, the channel properties are used to define corresponding queue parameters for each channel so that a queue pair may be generated for implementing each channel. One queue of the queue pair for implementing each channel is located on the hub whilst the other is located on the respective spoke.

A set of message propagation rules is then generated by the software executing on computer 40. These rules are used by the messaging software running on the hub and spokes such that messages emanating from the queues on the spokes are transferred to the corresponding queues on the hub and messages emanating from the queues on the hub are transferred to the corresponding queues on the spokes. In this example, one of the set of rules is that messages emanating from the queue used to transfer messages from computer 5 to the hub are then to be transferred from the corresponding queue on the hub to the queue on the hub used to transfer messages to computer 4.

The deployment package of source code for each spoke is then created by retrieving predefined source code from database 41 for implementing the queues and message propagation rules on each respective spoke from the database and adapting this predefined source code in accordance with the respective queue parameters. Similarly, a deployment package of source code for the hub is created by retrieving the predefined source code for implementing each queue on the hub. Again, the predefined source code is adapted in accordance with the queue parameters.

Further predefined source code for message routing is retrieved from database 41 and is adapted in accordance with the message propagation rules. At this point, the sections of user defined source code associated with decision boxes 13 and 21 are linked in to complete the message routing source code. The properties of the message routes between each decision box and the activities to which it is connected (for example, the message route between decision box 13 and activities 14 and 15) are entered by the user via input device 42. These properties specify a guard condition which determines which message route is taken by the message. The user-defined source code that calculates whether the guard condition is met is included as part of the deployment package for the hub and is executed at the appropriate time to determine the correct message route for each message.

In this example, as has already been described, messages sent to and from computer 1 designated “customer” are in the form of e-mail messages whilst those sent to and from computer 4 designated “Inventory” are in the form of XML files. Thus, the software executing on computer 40 retrieves the predefined source code from database 41 for carrying out the necessary message format transformation between these two message formats. This source code is also included in the deployment package of source code for the hub.

When executed on the hub and spokes, the deployment packages of source code correctly configure the messaging software to control the routing of messages between the computers 1 to 5 in accordance with the graphical description of the business process shown in FIG. 2.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of a particular type of signal bearing media that should be used to carry out the distribution. Examples of computer readable media include recordable-type media such as floppy disk, a hard disk drive, RAM and CD-ROMs as well as transmission-type media, such as digital and analogue communications links.

We claim:

1. A method for generating a hub and spoke messaging infrastructure for propagating messages used in the implementation of a process on a distributed system of computers, each of which is adapted to execute messaging software to enable each computer to communicate with the others in the distributed system, the method comprising producing a graphical description of the process and automatically creating source code for generating the hub and spoke messaging infrastructure by selecting and adapting appropriate portions of predefined source code in accordance with the graphical description of the process, the predefined source code using the messaging software to control the routing of messages between the computers:

2. A method according to claim 1, wherein the graphical description is a Unified Modelling Language (UML) Activity Graph description.

3. A method according to claim 1, wherein the graphical description comprises one or more of activities, objects, decision points and message routes.

4. A method according to claim 3, wherein the graphical description further comprises at least two partitions, each partition corresponding to one of the computers making up the distributed system, and the production of the graphical description further comprises the following steps:
a associating at least one channel having channel properties with each partition;
b assigning one channel to each message route;
c associating a respective section of user defined source code with each decision point, the user defined source code determining which one of a plurality of message routes the message is to be propagated by; and,
d designating one of the computers as the hub.

5. A method according to claim 4, wherein the user defined source code determines the message route from the content of the message.

6. A method according to claim 4, wherein the computer designated as the hub does not carry out any part of the process implementation.

7. A method according to claim 4, wherein the source code is automatically generated from the graphical description by:
a using the channel properties to define queue parameters for each channel so that appropriate queues for implementing each channel may be generated on the hub and spokes by the respective messaging software;
b generating a set of message propagation rules to be used by the messaging software running on the hub such that messages emanating from the queues on the spokes are transferred to the corresponding queues on the hub and messages emanating from the queues on the hub are transferred to the corresponding queues on the spokes;
c creating a deployment package of source code for each spoke, each deployment package comprising predefined source code for implementing the queues on each respective spoke, the predefined source code being adapted in accordance with the queue parameters; and,
d creating a deployment package of source code for the hub, the deployment package comprising:
i. predefined source code for implementing the queues on the hub, the predefined source code being adapted in accordance with the queue parameters;
ii. predefined source code for routing the messages, the predefined source code being adapted in accordance with the message propagation rules and including the sections of user defined source code associated with each decision point.

8. A method according to claim 7, wherein the deployment package of source code for the hub further comprises predefined source code for transforming the format of the messages.

9. Apparatus comprising a processor adapted to execute a program for capturing a graphical description of a process and automatically creating source code for generating a hub and spoke messaging infrastructure by selecting and adapting appropriate portions of predefined source code in accordance with the graphical description of the process.

10. A computer program comprising computer program code means adapted to perform the method of claim 1 when said program is run on a computer.

11. A computer program product comprising program code means stored on a computer readable medium for performing the method of claim 1 when said program product is run on a computer.
